(19) United States
(12) Patent Application Publication
(10) Pub. No.: US 2022/0380034 A1
(43) Pub. Date: Dec. 1, 2022

(54) METHODS OF VERTICAL TAKE-OFF/LANDING AND HORIZONTAL STRAIGHT FLIGHT OF AIRCRAFT AND AIRCRAFT FOR IMPLEMENTATION

(71) Applicant: HOVERSURF, INC., Wilmington, DE (US)

(72) Inventor: Aleksandr V. Atamanov, Saint Petersburg (RU)

(21) Appl. No.: 17/488,182

(22) Filed: Sep. 28, 2021

(30) Foreign Application Priority Data
Jun. 1, 2021 (RU) 2021115700

(51) Int. Cl. B64C 27/28; B64D 27/24; B64C 27/08; B64C 27/20

(52) U.S. Cl. CPC B64C 27/28; B64D 27/24; B64C 27/08; B64C 27/20

(57) ABSTRACT

Vertical take-off, landing and horizontal straight flight of an aircraft includes activation a plurality of front and rear lifting in-ring propellers, each of which is connected to a respective independently operating electric motor. In addition, horizontal straight flight of the aircraft includes activation of additional left and right pushing in-ring propellers, each of which is connected to an independently operating electric motor. The front and rear lifting in-ring propellers are respectively positioned generally horizontally and symmetrically opposite to one another and equidistantly relative to a longitudinal axis of the aircraft. The right pushing in-ring propeller and the left pushing in-ring propeller are positioned generally vertically and symmetrically opposite to one another and equidistantly relative to the longitudinal axis of the aircraft.

### CROSS-REFERENCE TO RELATED APPLICATIONS

This Application Claims priority to Russian patent application no. 2021115700, filed Jun. 1, 2021.

### TECHNICAL FIELD

The group of inventions described herein relates to aviation technology, namely, to aircraft capable of vertical take-off/landing and horizontal straight flight.

### BACKGROUND

From the state of the art, the Multi-rotor Heavy Convento-rotorcraft is known (see Patent of the Russian Federation No. 2521121 for an invention, published on Jun. 27, 2014).

The Convento-rotorcraft is made in the form of the high-positioned monoplane, having rotors in rotary annular channels on the wing consoles, a fuselage with two power beams pivotally mounted in a diamond-shaped rocker plan, which has the possibility of deflecting its beams in the longitudinal plane and equipped with bearing rotors on pylons on its opposite tops. The rotors are connected by transmission shafts to the engines of the power plant mounted in the root part of the wing.

The Convento-rotorcraft has the tail unit with an all-movable stabilizer, the three-rack retractable wheel landing gear, the wing is made in the form of combination of two wings with the close location to each other, mounted by the ledge. The front wing is higher than the rear with the negative degradation of the first to the second in the angle of attack. The inter-gondola sections of the front and rear wings are equipped with the slat and flap and are mounted so that between the rear edge of the front wing and the front edge of the rear wing, which has 45% of the area of the front wing, there is a narrow gap equal to 2.5% of the chord of the front wing at the distance between the middle lines of the profile of the front and rear wings, equal to 30% of the chord of the rear wing.

The disadvantages of the known technical solution are: need to turn the movers; low handling and maneuverability; low safety of take-off, flight and landing of aircraft due to the lack of protection of the rotors from collisions with the ground surface and other obstacles; and large weight and size parameters (characteristics) of the aircraft.

From the state of the art, the method of flying in the air with the possibility of vertical take-off and landing is known (see Patent of the Russian Federation No. 2566177 for an invention, published on Oct. 20, 2015).

The flight method involves the creation of the air flow directed from top to bottom by coaxial movers with blades rotating in opposite directions. The blades have the ability to rotate around their longitudinal axis with the change of the angle of attack. By changing the rotation angles of the movers blades during each rotation, ensure the creation of the horizontal component of the thrust vector and the stabilization of the flight. Horizontal thrust in the steady-state horizontal flight mode is created by the jet mover. By turning the blades of the mover to the angle of attack of 0° in the mode of prolonged horizontal flight, the closed aerodynamic surface is formed—the rotating wing with the possibility of creating the climb power. The movers are connected to the engine through the gear drive system. The mover blades are connected to tilt system, gyroscope and control system.

The disadvantages of the known technical solution are: low reliability and controllability, since for horizontal flight there is one mover installed in the center; possibility of only horizontal straight flight; jet mover is used, which leads to the deterioration of maneuverability and environmental friendliness; low safety of take-off, flight and landing of the aircraft; and lack of protection of the rotors from collisions with the ground surface and other obstacles.

From the state of the art, the method of flight of aircraft and aircraft for its implementation are known (see International Publication of the Application WO2017198082 for an invention, published on May 8, 2017).

The disadvantages of the technical solution known from the state of the art are: need to change the horizontal position of the airframe for straight flight; need to use partially the thrust of the lifting movers to create the force pushing the aircraft forward; low safety of take-off, flight and landing of the aircraft; low flight speed; low flight comfort of the aircraft for passengers; low reliability.

An objective of the group of inventions described herein is to create a compact, safe aircraft during take-off/landing and flight with high maneuverability and controllability, as well as increased flight speed.

### SUMMARY

The technical results of the group of inventions described herein include:
reduction of energy costs for horizontal straight flight;
increased flight stability and comfort;
improved flight handling and maneuverability;
improving environmental friendliness;
reduced drag during horizontal straight flight;
increasing the thrust and flight speed of the aircraft;
increasing the safety of take-off, flight and landing of aircraft;
increased fail-safety while maintaining the position of the aircraft in flight;
ensuring the protection of propellers from collisions with the ground surface and other obstacles during flight;
reducing the overall dimensions of the aircraft (increasing the compactness of the aircraft);
possibility of both horizontal straight flight and vertical take-off/landing.

The technical results of the group of inventions described herein are achieved by the fact that the aircraft for vertical take-off/landing and horizontal straight flight contains:
performing a vertical take-off or landing of the aircraft by activating a plurality of front lifting in-ring propellers and a plurality of rear lifting in-ring propellers, each of the front lifting in-ring propellers and the rear lifting in-ring propellers being mounted to a load-bearing carriage frame and is connected to a respective independently operating electric motor, the front lifting in-ring propellers and the rear lifting in-ring propellers being present in equal numbers, the front lifting in-ring propellers being positioned generally horizontally and symmetrically opposite to one another and equidistantly relative to the longitudinal axis of the aircraft, the rear lifting in-ring propellers being positioned generally horizontally and symmetrically opposite to one another and equidistantly relative to the longitudinal axis of the aircraft; and
carrying out a horizontal straight flight of the aircraft by activating at least one right pushing in-ring propeller and at least one left pushing in-ring propeller, each of the at least one right pushing in-ring propeller and the at least one left pushing propeller being connected to a respective independently operating electric motor, the at least one right pushing in-ring propeller and the at least one left pushing in-ring propeller being present in equal numbers, and the at least one right pushing in-ring propeller and the at least one left pushing in-ring propeller being positioned generally vertically and symmetrically opposite to one another and equidistantly relative to the longitudinal axis of the aircraft.

In an embodiment of the aircraft, the independently operating electric motors of the lifting front and rear in-ring propellers are mounted on the load-bearing carriage frame, and the load-bearing carriage frame is tubular and may be formed of pipes and overlap to form a cross.

In an embodiment of the aircraft, the independently operating electric motors of the pushing in-ring propellers are installed on a at least one common load bearing frame that is oriented perpendicularly to a longitudinal axis of the aircraft, at least one of the independently operating electric motors of the pushing in-ring propellers being on a right side of the longitudinal axis of the aircraft and at least one of the independently operating electric motors of the pushing in-ring propellers being on a left side of the longitudinal axis of the aircraft.

In one embodiment of the aircraft, the pushing in-ring propellers are positioned closer to a middle than to opposite ends of the at least one common load-bearing frame and closer to a rear of the aircraft than to a front of the aircraft.

In another embodiment of the aircraft, at least one of the pushing in-ring propellers is positioned on a right side of the longitudinal axis of the aircraft and at least one of the pushing in-ring propellers is located on a left side of the longitudinal axis of the aircraft.

In an embodiment of the aircraft, any number of pushing in-ring propellers may be included and a total number of the pushing in-ring propellers on a right side of the longitudinal axis of the aircraft is equal to a total number of the pushing in-ring propellers located on a left side of the longitudinal axis of the aircraft.

In an embodiment of the aircraft, at least one of the lifting in-ring propellers is positioned on a right side of the longitudinal axis of the aircraft and at least one of the lifting in-ring propellers is located on a left side of the longitudinal axis of the aircraft, and total number of the lifting in-ring propellers on the right side of the longitudinal axis is equal to the total number of the lifting in-ring propellers on the left side of the longitudinal axis.

### BRIEF DESCRIPTION OF THE DRAWINGS

The features and essence of the group of inventions described herein are explained in the following detailed description, illustrated by drawings (see FIGS. 1-2), where the following is shown.

FIG. 1 shows a prior art aircraft with front and rear movers-propellers (rotors).

FIG. 2 shows an embodiment of an aircraft for vertical take-off/landing and horizontal straight flight with front and rear in-ring lifting propellers and additional auxiliary in-ring pushing propellers.

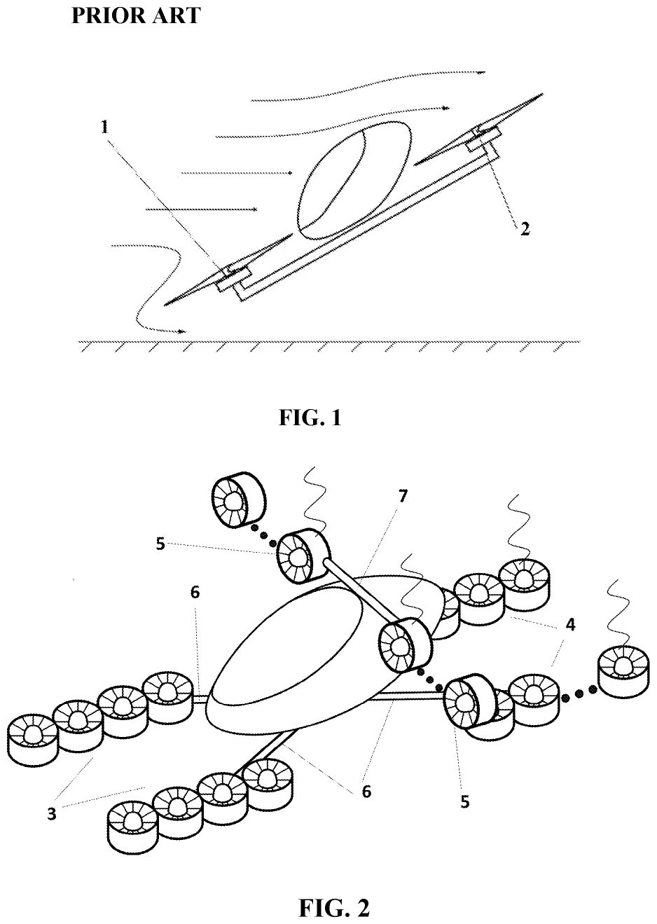

The reference numbers in FIGS. 1-2 indicate the following features of the exemplary embodiments:

1—front movers—main rotors (lifting in-ring propellers);

2—rear movers—main rotors (lifting in-ring propellers);

3—groups of front in-ring lifting propellers;

4—groups of rear in-ring lifting propellers;

5—additional (auxiliary) running (pushing) right and left in-ring propellers;

6—load-bearing power platform—carriage frame made of tubes/pipes that overlap forming a cross, for installing electric motors of lifting front and rear propellers;

7—load-bearing power platform—frame made of tubes/pipes for installing electric motors of right and left pushing propellers.

### DETAILED DESCRIPTION

An exemplary aircraft for implementing methods of vertical take-off/landing and horizontal straight flight (see FIG. 2) includes a group of front 3 and rear 4 lifting propellers for vertical take-off/landing and a group of additional-auxiliary running (pushing) propellers 5. The lifting front 3 and rear 4 propellers and the additional—auxiliary running (pushing) propellers include multiple blades that are enclosed in a circumferentially closed ring-shaped casing/housing and are referred to as in-ring propellers.

FIG. 2 shows one of the embodiments of the aircraft with two symmetrical and opposite groups of front 3 lifting in-ring propellers and two symmetrical and opposite groups of rear 4 lifting in-ring-propellers relative to each other. Each of the four groups 3, 4 contains four lifting propellers. The aircraft also contains groups of additional auxiliary running (pushing) in-ring propellers 5 (two propellers on the left side of the aircraft and two propellers on the right side of the aircraft relative to the longitudinal axis of the aircraft).

The lifting front 3 and rear 4 propellers are installed in equal numbers, at a certain distance from each other, at the front and rear of the aircraft, opposite and symmetrically relative to each other and the longitudinal axis of the aircraft, on a load-bearing power platform—carriage frame 6 made of two pipes of square, round or rectangular cross-section of the same size and length, overlapping forming a cross. Each of the front 3 and rear 4 impellers is connected to an independently operating electric motor, each of which is fixed at its base on the end sections of the pipes of the load-bearing power platform—carriage frame 6. The front 3 and rear 4 lifting in-ring propellers are oriented horizontally and have vertical axes of rotation of the blades.

Additional-auxiliary running (pushing) movers—propellers 5 are installed in equal numbers at the left and right sides of the aircraft, opposite and symmetrically relative to each other and the longitudinal axis of the aircraft. The pushing in-ring propellers 5 can be installed both on one common load-bearing power platform—frame 7 in the form of pipe perpendicular to the longitudinal axis of the aircraft (see FIG. 2), and on two separate load-bearing power platforms—frames in the form of pipes perpendicular to the longitudinal axis of the aircraft, on the left and to the right relative to the sides of the aircraft (not shown). Each running (pushing) propeller 5 is connected to an independently operating electric motor, each of which is fixed at its base on the end sections of the pipes of the load-bearing power platform—frame 7. The running (pushing) propellers 5 are oriented vertically and perpendicularly to the longitudinal axis of the aircraft and have the horizontal axis of rotation of the blades.

FIG. 2 shows one of the embodiments of the aircraft, but there are also other possible embodiments of the aircraft with a different number of lifting and pushing movers—propellers 3, 4, 5. At the same time, the total number of front 3 and rear 4 lifting propellers as well as the number of propellers in the groups can be the same. The number of pushing (running) propellers 5 on each side of the aircraft can be the same.

It is also possible to construct the aircraft with only one additional-auxiliary running (pushing) in-ring propeller 5, which is installed at the central, rear part of the aircraft, on the load-bearing power platform—carriage frame perpendicular to the longitudinal axis of the aircraft in such a way that the propeller blades 5 rotate around the horizontal axis parallel to the longitudinal axis of the aircraft.

The aircraft known from the state of the art carry out the horizontal straight flight due to change in the pitch angle (the aircraft leans forward) (see FIG. 1). The angle changes by increasing the thrust on the rear propellers (movers) 2, thereby changing the angle of the aircraft and the thrust vector appears that moves the aircraft forward such that the front propellers movers 1 are lower than the rear propellers (movers) 2.

In the aircraft described herein, for horizontal straight movement, it is not necessary to change the pitch angle, and the aircraft remains in the horizontal plane, thereby reducing drag and increasing the thrust and flight speed of the aircraft. This is achieved by installing one additional-auxiliary running (pushing) in-ring propeller or a group of additional-auxiliary running (pushing) in-ring propellers 5.

Since for horizontal straight movement, the resulting vertical and horizontal thrust of the rear in-ring propellers 2 is not used (see FIG. 1), and if the thrust of the pushing propellers 5 is completely removed, then the energy requirements for horizontal straight flight are reduced.

Improved controllability and maneuverability is achieved by changing the thrust on additional auxiliary running propellers 5: for turning to the left, the thrust of the right horizontal pushing in-ring propeller or the thrust of the group of right pushing in-ring propellers 5 increases, and for turning to the right, the thrust of the left horizontal pushing in-ring propeller or the thrust of the group of left horizontal pushing in-ring propeller 5 increases. Thus, there is the deviation of the aircraft on the course and the correction of the course.

By adjusting the speed of rotation of the in-ring propeller blades 3, 4, 5, independently of each separately or simultaneously of each, using independently operating electric motors, the aircraft can perform various actions (maneuvers) during flight (for example, turn, hover), as well as achieve the certain balance to ensure stability and comfort of flight.

Increasing the safety of take-off/landing and flight of aircraft, and providing protection from collisions with the ground surface and other obstacles during flight are achieved by using as in-ring propellers 3, 4, 5, the blades of which operate in a circumferentially closed (closed-loop) housing or pipe, instead of open rotating blades.

Increased fail-safety while maintaining the position of the aircraft in flight and flight safety are ensured by duplicating the RMG of the aircraft (i.e. ,a group of propellers 3, 4 and 5 is installed),Increasing the environmental friendliness of the aircraft is achieved through the use of electric motors of the propellers 3, 4, 5.

The increase in the compactness of the aircraft (reduction of overall dimensions, the area of the aircraft) is achieved by installing front 3 and rear 4 lifting in-ring propellers of and additional pushing in-ring propellers 5 of smaller sizes instead of larger propellers (rotors).

The use of the additional auxiliary pushing in-ring propellers 5 provides for a significantly increase of the thrust and flight speed of the aircraft.

The aircraft described herein for the implementation of described flight method is compact, safe during take-off/landing and flight, and is made with the possibility of both horizontal straight-line flight and vertical take-off/landing, and has high maneuverability and controllability, as well as increased flight speed.

The analysis of the state of the art made it possible to establish: there are no analogs with the set of essential features that are identical and similar to the essential features of the group of inventions described herein, which indicates that the group of inventions described herein meets the “novelty” patentability condition. The results of the search for known solutions in order to identify essential features that coincide with the essential features of the group of inventions described herein that are distinctive from analogues showed that they do not explicitly follow from the state of the art, and the influence of the distinctive essential features on the technical results indicated by the authors has not been established. Therefore, the group of inventions described herein corresponds to the patentability condition “inventive level”.

Despite the fact that the above-described group of inventions is described with reference to its certain embodiments, it will be clear to specialists in this field of technology that various changes in the form and content of the group of inventions described herein can be made in it without deviation from the essence and scope of the inventions described herein, which are determined by the attached claims, taking into account the description and drawings.

1. A method of vertical take-off, landing and horizontal straight flight of an aircraft, the method comprising:
performing a vertical take-off or landing of the aircraft by activating a plurality of front lifting in-ring propellers and a plurality of rear lifting in-ring propellers, each of the front lifting in-ring propellers and the rear lifting in-ring propellers being mounted to a load-bearing carriage frame and is connected to a respective independently operating electric motor;
wherein the front lifting in-ring propellers and the rear lifting in-ring propellers are present in equal numbers; and
wherein the front lifting in-ring propellers are positioned generally horizontally and symmetrically opposite to one another and equidistantly relative to the longitudinal axis of the aircraft; and
wherein the rear lifting in-ring propellers are positioned generally horizontally and symmetrically opposite to one another and equidistantly relative to the longitudinal axis of the aircraft;
carrying out a horizontal straight flight of the aircraft by activating at least one right pushing in-ring propeller and at least one left pushing in-ring propeller, each of the at least one right pushing in-ring propeller and the at least one left pushing in-ring propeller being connected to a respective independently operating electric motor;
wherein the at least one right pushing in-ring propeller and the at least one left pushing in-ring propeller are present in equal numbers; and
wherein the at least one right pushing in-ring propeller and the at least one left pushing in-ring propeller are positioned generally vertically and symmetrically opposite to one another and equidistantly relative to the longitudinal axis of the aircraft.

2. The method of claim 1, wherein the independently operating electric motors of the front and rear lifting in-ring propellers are mounted on the load-bearing carriage frame, and wherein the load-bearing carriage frame is tubular.

3. The method of claim 1, wherein the independently operating electric motors of the pushing in-ring propellers are installed on at least one common load bearing frame that is oriented perpendicularly to a longitudinal axis of the aircraft, at least one of the independently operating electric motors of the pushing in-ring propellers being on a right side of the longitudinal axis of the aircraft and at least one of the independently operating electric motors of the pushing in-ring propellers being on a left side of the longitudinal axis of the aircraft.

4. The method of claim 3, wherein the pushing in-ring propellers are positioned closer to a middle than to opposite ends of the at least one common load-bearing frame and closer to a rear of the aircraft than to a front of the aircraft.

5. The method of claim 1, wherein at least one of the pushing in-ring propellers is positioned on a right side of the longitudinal axis of the aircraft and at least one of the pushing in-ring propellers is located on a left side of the longitudinal axis of the aircraft.

6. The method of claim 1, wherein a total number of the pushing in-ring propellers on a right side of the longitudinal axis of the aircraft is equal to a total number of the pushing in-ring propellers located on a left side of the longitudinal axis of the aircraft.

7. The method of claim 1, wherein at least one of the lifting in-ring propellers is positioned on a right side of the longitudinal axis of the aircraft and at least one of the lifting in-ring propellers is located on a left side of the longitudinal axis of the aircraft.

8. The method of claim 1, wherein a total number of the front lifting in-ring propellers is equal to a total number of the rear lifting in-ring propellers.

9. An aircraft for vertical take-off, landing and horizontal straight flight, the aircraft comprising:
a plurality of front lifting in-ring propellers and a plurality of rear lifting in-ring propellers, each of the front lifting in-ring propellers and the rear lifting propellers being mounted to a load-bearing carriage frame and is connected to a respective independently operating electric motor and is configured to facilitate a vertical take-off or landing of the aircraft when activated;
at least one right pushing in-ring propeller and at least one left pushing in-ring propeller each configured to facilitate a horizontal straight flight of the aircraft when activated, each of the at least one right pushing in-ring propeller and the at least one left pushing in-ring propeller being connected to a respective independently operating electric motor;
wherein the front lifting in-ring propellers and the rear lifting in-ring propellers are present in equal numbers; and
wherein the front lifting in-ring propellers are positioned generally horizontally and symmetrically opposite to one another and equidistantly relative to the longitudinal axis of the aircraft; and
wherein the rear lifting in-ring propellers are positioned generally horizontally and symmetrically opposite to one another and equidistantly relative to the longitudinal axis of the aircraft;
wherein the at least one right pushing in-ring propeller and the at least one left pushing in-ring propeller are present in equal numbers; and
wherein the at least one right pushing in-ring propeller and the at least one left pushing in-ring propeller are positioned generally vertically and symmetrically opposite to one another and equidistantly relative to the longitudinal axis of the aircraft.

10. The aircraft of claim 9, wherein the independently operating electric motors of the front and rear lifting in-ring propellers are mounted on the load-bearing carriage frame, and wherein the load-bearing carriage frame is tubular.

11. The aircraft of claim 9, wherein the independently operating electric motors of the pushing in-ring propellers are installed on at least one common load bearing frame that is oriented perpendicularly to a longitudinal axis of the aircraft, at least one of the independently operating electric motors of the pushing in-ring propellers being on a right side of the longitudinal axis of the aircraft and at least one of the independently operating electric motors of the pushing in-ring propellers being on a left side of the longitudinal axis of the aircraft.

12. The aircraft of claim 11, wherein the pushing in-ring propellers are positioned closer to a middle than to opposite ends of the at least one common load-bearing frame and closer to a rear of the aircraft than to a front of the aircraft.

13. The aircraft of claim 9, wherein at least one of the pushing in-ring propellers is positioned on a right side of the longitudinal axis of the aircraft and at least one of the pushing in-ring propellers is located on a left side of the longitudinal axis of the aircraft.

14. The aircraft of claim 9, wherein a number of the pushing in-ring propellers on a right side of the longitudinal axis of the aircraft is equal to a total number of the pushing in-ring propellers located on a left side of the longitudinal axis of the aircraft.

15. The aircraft of claim 9, wherein at least one of the lifting in-ring propellers is positioned on a right side of the longitudinal axis of the aircraft and at least one of the lifting in-ring propellers is located on a left side of the longitudinal axis of the aircraft.

16. The aircraft of claim 9, wherein a total number of the front lifting in-ring propellers is equal to a total number of the rear lifting in-ring propellers.
